(19) United States
(12) Patent Application Publication
(10) Pub. No.: US 2015/0306891 A1
(43) Pub. Date: Oct. 29, 2015

(54) IMAGE PROCESSING APPARATUS, IMAGE PROCESSING METHOD, AND COMPUTER-READABLE STORAGE MEDIUM

(71) Applicants: Norimasa Sohgawa, Kanagawa (JP); Masanori Hirano, Kanagawa (JP); Shinichi Hatanaka, Tokyo (JP)

(72) Inventors: Norimasa Sohgawa, Kanagawa (JP); Masanori Hirano, Kanagawa (JP); Shinichi Hatanaka, Tokyo (JP)

(73) Assignee: RICOH COMPANY, LTD., Tokyo (JP)

(21) Appl. No.: 14/691,844

(22) Filed: Apr. 21, 2015

(30) Foreign Application Priority Data
Apr. 25, 2014 (JP) 2014-092073

(51) Int. Cl. B41J 29/38

(52) U.S. Cl. CPC B41J 29/38

(57) ABSTRACT

An image processing apparatus includes an acquisition unit configured to acquire multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and a first generator configured to generate first print data from the multi-layer image data so as to satisfy a first condition in which dots corresponding to pixels on different layers of the multi-layer image are recorded by one scan in second and subsequent scans performed on a same recording area of the recording medium.

### CROSS-REFERENCE TO RELATED APPLICATION

The present application claims priority to and incorporates by reference the entire contents of Japanese Patent Application No. 2014-092073 filed in Japan on Apr. 25, 2014.

### BACKGROUND OF THE INVENTION

1. Field of the Invention

Embodiments of the present invention relate generally to an image processing apparatus, an image processing method, and a computer-readable storage media.

2. Description of the Related Art

Inkjet recording apparatuses configured to form an image by ejecting droplets of ink, for example, from nozzles are known. Techniques for reducing color unevenness and streak due to dots stacked in a manner specific to inkjet printing are conventionally disclosed.

For example, a technique for reducing such color unevenness and streak by using, in lieu of a single-pass method, a multi-pass method is known. An example of this technique is disclosed in Japanese Laid-open Patent Publication No. 2013-094734. According to the technique disclosed in Japanese Laid-open Patent Publication No. 2013-094734, a plurality of print layers is overlaid on one another by overlaying, on a print layer already formed with ejected dots, another print layer formed with dots which are lower in tonal value than those of the already-formed print layer.

Such a conventional technique using a multi-pass method forms a single-layer print layer through a scanning motion (hereinafter, “scan”) performed by a recording unit a plurality of times, thereby reducing color unevenness and streak. Accordingly, the conventional technique is disadvantageous in that time necessary for forming a multi-layer image by stacking a plurality of dots increases with the number of the layers. Hence, it has conventionally been difficult to reduce degradation in image quality while simultaneously achieving reduction in image forming time for a multi-layer image.

### SUMMARY OF THE INVENTION

It is an object of the present invention to at least partially solve the problems in the conventional technology.

According to an embodiment, there is provided an image processing apparatus that includes an acquisition unit configured to acquire multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and a first generator configured to generate first print data from the multi-layer image data so as to satisfy a first condition in which dots corresponding to pixels on different layers of the multi-layer image are recorded by one scan in second and subsequent scans performed on a same recording area of the recording medium.

According to another embodiment, there is provided a non-transitory computer-readable storage medium with an executable program stored thereon and executed by a computer. The program instructs the computer to perform: acquiring multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and generating first print data from the multi-layer image data so as to satisfy a first condition in which dots corresponding to pixels on different layers of the multi-layer image are recorded by one scan in second and subsequent scans performed on a same recording area of the recording medium.

According to still another embodiment, there is provided an image processing method that includes acquiring multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and generating first print data from the multi-layer image data so as to satisfy a first condition in which dots corresponding to pixels on different layers of the multi-layer image are recorded by one scan in second and subsequent scans performed on a same recording area of the recording medium.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an image processing system according to a first embodiment;

FIGS. 2A and 2B are explanatory diagrams of recording methods that can be used by a recording unit of the first embodiment;

FIG. 3 is a functional diagram of the image processing system of the first embodiment;

FIGS. 4A and 4B are explanatory diagrams of conventional images;

FIG. 5 is an explanatory diagram of how the recording unit of the first embodiment operates;

FIG. 6 is a diagram illustrating an example of a recording area on a recording medium scanned four times in a second direction;

FIG. 7 is an explanatory diagram of coverages of the recording medium with use of conventional print data;

FIG. 8 is an explanatory diagram of an example of a scan performed a plurality of times in the second direction;

FIG. 9 is a schematic diagram illustrating an example of dots recorded on the recording medium by the recording unit;

FIG. 10 illustrates surface unevenness of a single-layer image;

FIGS. 11A and 11B are vertical cross-sectional diagrams each illustrating an example of a multi-layer image;

FIG. 12 is a flowchart illustrating an example of a routine for image processing;

FIG. 13 is an explanatory diagram of an example of how a multi-layer image is formed;

FIG. 14 is an explanatory diagram of an example of how a multi-layer image is formed;

FIG. 15 is an explanatory diagram of an example of how a multi-layer image is formed;

FIG. 16 is a diagram illustrating an example of an image processing system according to a second embodiment;

FIG. 17 is a flowchart illustrating an example of a routine for image processing; and

FIG. 18 is an explanatory diagram of an example of a hardware configuration of image processing apparatuses.

### DETAILED DESCRIPTION OF THE PREFERRED EMBODIMENTS

Exemplary embodiments of the present invention are described in detail below with reference to the accompanying drawings.

### First Embodiment

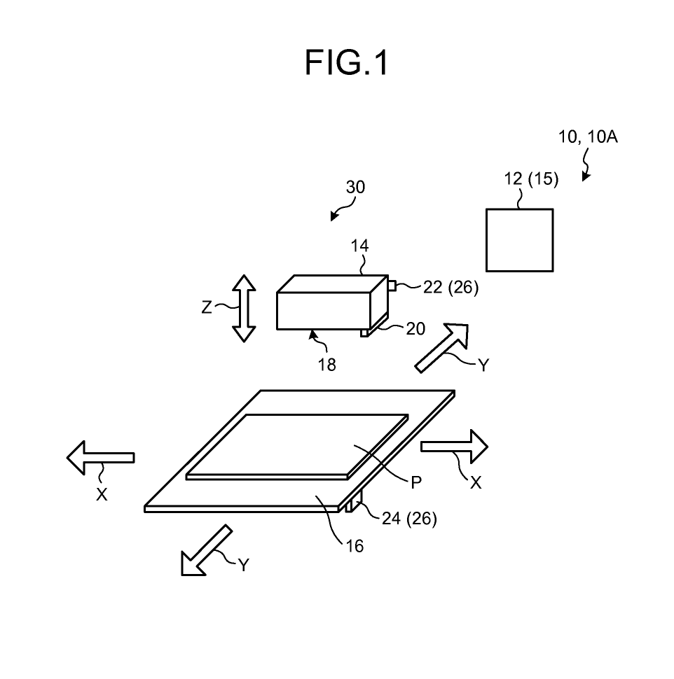

FIG. 1 is a diagram illustrating an example of an image processing system 10 according to a first embodiment of the present invention.

The image processing system 10 includes an image processing apparatus 12 and a recording apparatus 30. The image processing apparatus 12 and the recording apparatus 30 are communicably connected to each other.

The recording apparatus 30 includes a recording unit 14, a driven stage 16, and a driver 26. The recording apparatus 30 includes a plurality of nozzles 18. The recording unit 14 is an inkjet-type recording unit that records dots by ejecting droplets respectively from the plurality of nozzles 18. The nozzles 18 are arranged on a surface, of the recording unit 14, facing the driven stage 16.

In the first embodiment, the droplets are droplets of ink containing colorant. In the first embodiment, the ink contains light-curable resin curable by light irradiation. The light may be ultraviolet light, for example. Accordingly, after being ejected, the ink of the first embodiment is cured by light radiation. Note that the droplets to be ejected by the recording unit 14 are not limited to those containing light-curable resin.

An irradiator 20 is arranged on the surface, of the recording unit 14, facing the driven stage 16. The irradiator 20 irradiates a recording medium P with light of a wavelength that cures the ink ejected from the nozzles 18.

The driven stage 16 holds the recording medium P onto which ink is to be ejected. The driver 26 moves the recording unit 14 and the driven stage 16 relative to each other in the vertical direction (the direction indicated by arrow Z in FIG. 1), a first direction Y perpendicular to the vertical direction Z, and a second direction X perpendicular to the vertical direction Z and the first direction Y. The first direction Y and the second direction X are orthogonal to each other.

The first direction Y and the second direction X are not necessarily orthogonal to each other but can be any directions intersecting each other.

In the first embodiment, the plane containing the second direction X and the first direction Y corresponds to an XY plane lying along the surface, of the driven stage 16, facing the recording unit 14.

The driver 26 includes a first driver 22 and a second driver 24. The first driver 22 moves the recording unit 14 in the vertical direction Z, the second direction X, and the first direction Y. The second driver 24 moves the driven stage 16 in the vertical direction Z, the second direction X, and the first direction Y. The recording apparatus 30 may alternatively be configured to include only any one of the first driver 22 and the second driver 24.

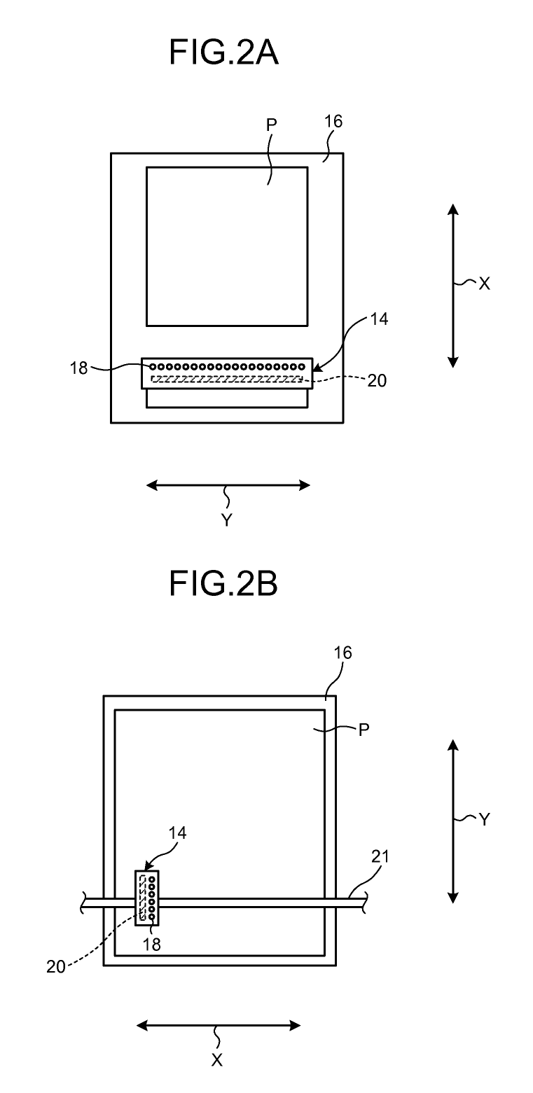

FIGS. 2A and 2B are explanatory diagrams of recording methods that can be used by the recording unit 14.

FIG. 2A is an explanatory diagram of the recording unit 14 that uses a one-pass method (which may be sometimes referred to as “single-pass method”). The one-pass method is a recording method of forming an image by causing the recording medium P to relatively pass through the recording unit 14 in the second direction X. The recording unit 14 that uses this method includes an array of the plurality of nozzles 18 arranged at least in the first direction Y. The recording unit 14 may alternatively include an array of the plurality of nozzles 18 arranged along both the second direction X and the first direction Y. An image is formed on the recording medium P by causing ink to be ejected from the nozzles 18 of the recording unit 14 and, simultaneously, moving the recording unit 14 and the recording medium P relatively in the second direction X. To form a multi-layer image by overlaying images of a plurality of layers, relative movement of the recording medium P in the vertical direction Z is additionally applied.

FIG. 2B is an explanatory diagram of the recording unit 14 that uses a multi-pass method to which the first embodiment is directed. In the first embodiment, the multi-pass method is a recording method of forming an image by moving the recording unit 14 across the recording medium P relatively in the second direction X and, simultaneously, moving the recording medium P relatively in the first direction Y. The recording unit 14 that uses this method includes an array of the plurality of nozzles 18 arranged at least along the first direction Y.

More specifically, the recording unit 14 using the multi-pass method is supported by a support 21 that is elongated in the second direction X in a manner that allows the recording unit 14 to perform a scanning motion (hereinafter, “scan”) in the second direction X. The recording unit 14 is moved to perform a scan in the second direction X along the support 21. Each time the recording unit 14 is moved to perform a scan in the second direction X, the recording unit 14 is moved a predetermined travel in the first direction Y relative to the recording medium P. This travel is shorter than the length from one end to the other end in the first direction Y of the plurality of nozzles 18 on the recording unit 14. Accordingly, the array of the plurality of nozzles 18 arranged along the first direction Y is divided into groups each containing two or more of the nozzles 18 consecutively arranged in the first direction Y. Each time the recording unit 14 is moved to perform a scan in the second direction X, the recording unit 14 is relatively moved a travel, which corresponds to the group of the nozzles 18, in the first direction Y. In the multi-pass method, an image of one layer is formed by performing a scan in the second direction X a plurality of times on a same recording area, across which the recording unit 14 moves along the second direction X in one scan, of the recording medium P. An image is formed on the recording medium P in this manner. To form a multi-layer image by overlaying images of a plurality of layers, relative movement of the recording medium P in the vertical direction Z is additionally applied. More specifically, the “multi-pass method”, to which the first embodiment is directed, records dots D with ink ejected from the nozzles 18 that are different along the second direction X.

Meanwhile, in FIGS. 2A and 2B, the nozzles 18 arranged on the recording unit 14 have openings facing the driven stage 16. Hence, each of the nozzles 18 is arranged to be capable of ejecting ink toward the driven stage 16.

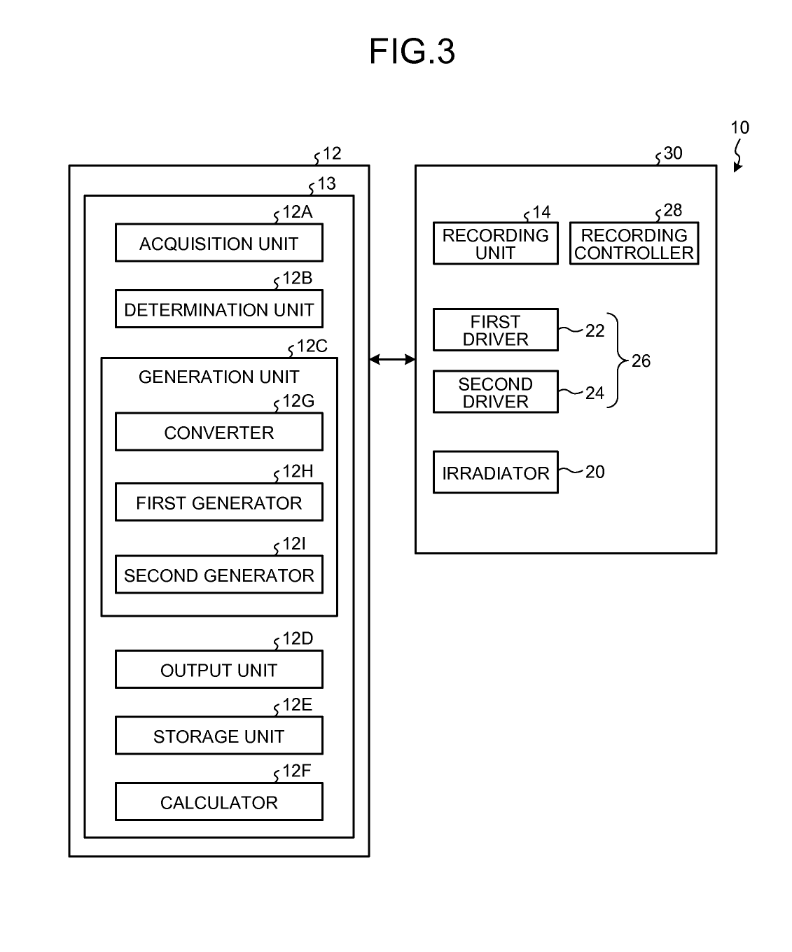

FIG. 3 is a functional block diagram of the image processing system 10.

The image processing apparatus 12 includes a main control unit 13. The main control unit 13 is a computer including a CPU (central processing unit) and provides overall control of the image processing apparatus 12. The main control unit 13 may alternatively be configured without a general-purpose CPU. For instance, the main control unit 13 may be made up of a circuit and the like.

The main control unit 13 includes an acquisition unit 12A, a determination unit 12B, a generation unit 12C, an output unit 12D, a storage unit 12E, and a calculation unit 12F.

Some or all of the acquisition unit 12A, the determination unit 12B, the generation unit 12C, the output unit 12D, and the calculation unit 12F may be implemented by causing a processing device such as the CPU to execute program instructions or, in short, by software or, alternatively, by hardware such as an IC (integrated circuit) or, further alternatively, by a combination of software and hardware.

The acquisition unit 12A acquires image data. The image data represents an image to be formed by the recording unit 14 of the recording apparatus 30. The acquisition unit 12A may acquire the image data from an external device via a communication unit (not shown) or, alternatively, may acquire the image data from a storage unit (not shown) provided in the image processing apparatus 12.

The image data is, for example, vector image data or raster image data. In the first embodiment, an example in which the acquisition unit 12A acquires vector image data is described.

In the first embodiment, the acquisition unit 12A acquires, as the image data, image data representing an image to be formed with one layer of dots or multi-layer image data representing a multi-layer image to be formed by overlaying a plurality of layers of dots. The multi-layer image data is, more specifically, image data representing a multi-layer image to be formed by stacking a plurality of dots at positions, each corresponding to a same pixel location, on the recording medium P.

Hereinafter, an image having one layer of dots is referred to as a “single-layer image”. Hereinafter, image data representing a single-layer image is referred to as “single-layer image data”.

Single-layer image data contains image data for forming an image of a single layer. Multi-layer image data contains image data for forming images of a plurality of layers. The multi-layer image data includes, for example, image data each representing an image of one of layers and layer indicator information that indicates ordinal positions of the layers of the respective image data on an assumption that a layer closest to the recording medium P is the first layer. The multi-layer image data has a structure in which the image data and the layer indicator information indicating the ordinal positions of the image data are associated with each other. The multi-layer image data is not limited to such a data form. Any image data for forming a multi-layer image can be used as the multi-layer image data.

The determination unit 12B determines whether or not the image data acquired by the acquisition unit 12A is multi-layer image data. In the first embodiment, the determination unit 12B determines which one of single-layer image data and multi-layer image data the image data acquired by the acquisition unit 12A is.

For example, the determination unit 12B may determine whether or not the image data acquired by the acquisition unit 12A contains image data for a plurality of layers, thereby determining whether or not the image data is multi-layer image data. Alternatively, a configuration in which the image data acquired by the acquisition unit 12A contains identification information for identifying which one of multi-layer image data or single-layer image data the image data is may be employed. With this configuration, the determination unit 12B can determine whether or not the image data acquired by the acquisition unit 12A is multi-layer image data by reading the identification information contained in the image data.

The generation unit 12C generates, from the image data acquired by the acquisition unit 12A, print data representing an image that can be formed by the recording unit 14 of the recording apparatus 30. The print data is data in which the nozzles 18, each for recording a dot corresponding to a pixel, are assigned to respective pixels included in the image data.

The generation unit 12C generates, as the print data, first print data if the image data acquired by the acquisition unit 12A is multi-layer image data and, furthermore, if the recording unit 14, from which the image is to be output, uses the multi-pass method (FIG. 2B). The generation unit 12C generates, as the print data, third print data if the image data acquired by the acquisition unit 12A is single-layer image data.

The first print data is print data generated from the multi-layer image data so as to satisfy a first condition. The first condition (which will be described in detail later) is that dots corresponding to pixels on different layers of a multi-layer image are to be recorded by one scan in the second and subsequent scans performed on a same recording area of the recording medium P.

In the first embodiment, a “scan” denotes a scanning motion performed by the recording unit 14 in the second direction X (see FIG. 2B).

The third print data is print data in which the nozzles 18, each for recording a dot corresponding to a pixel, are assigned to respective pixels included in the single-layer image data.

In the first embodiment, the generation unit 12C includes a converter 12G, a first generator 12H, and a second generator 12I.

The converter 12G converts the image data acquired by the acquisition unit 12A into raster image data in which each pixel is represented by a density value. The converter 12G also performs color-space conversion to adjust a color space of the image data to a color space of ink ejected by the recording unit 14. For instance, the converter 12G may convert an RGB color space to a CMYK color space.

The converter 12G also assigns the nozzles 18, each for recording a dot corresponding to a pixel, to the respective pixels included in the image data. For instance, assume that the recording unit 14 records dots using the multi-pass method (see FIG. 2B), and that the plurality of nozzles 18 (18₁ to 18ₙ) (n is an integer greater than one) is arranged in an array along the first direction Y (see FIG. 2B) (18₁ to 18ₙ are not specifically labeled in FIG. 2B). In this case, for instance, for each of scans in the second direction X which is to be performed at each position in the first direction Y, the converter 12G reads a pixel row (one line) of image data in the first direction Y, along which the nozzles 18 are arranged, assigns the nozzle 18₁ to a pixel on one end of the pixel row in the first direction Y, and assigns the respective nozzles 18₂ to 18ₙ to the other pixels on the same pixel row and arranged in the first direction Y toward the other end in a one-to-one relation.

For instance, the converter 12G may apply, as initial assignment, a predetermined assignment of the nozzles 18, each for recording the dot D corresponding to a pixel, to respective pixels included in image data. For instance, the converter 12G may read the image data one pixel row by one pixel row (line by line) in the direction corresponding to the first direction Y, along which the array of the nozzles 18 is arranged, and assign the nozzle 18₁ to a pixel on one end of the pixel row in the first direction Y. The converter 12G may assign the respective nozzles 18₂ to 18, to the other pixels on the same pixel row and arranged in the first direction Y toward the other end in a one-to-one relation.

If the image data acquired by the acquisition unit 12A is multi-layer image data, the converter 12G assigns, in a manner similar to that described above, the nozzles 18 to pixels included in the image data for each of image data associated with respective layer indicator information contained in the multi-layer image data. Accordingly, the converter 12G assigns the nozzles 18, each for recording a dot, to respective pixels included in the image data of each of the layers included in the multi-layer image.

At this time, the converter 12G assigns the nozzles 18 in one-to-one relation to the pixels on each layer of the multi-layer image data so that dots corresponding pixels on different layers at a same pixel location are recorded by a same one of the nozzles 18.

Meanwhile, an image such as a single-layer image or a multi-layer image formed on the recording medium P using a conventional technique can have unintended color unevenness or streak resulting from variation in amounts of ink ejected from the nozzles 18, tilt of an ejecting direction (mis-directed ejection), or the like.

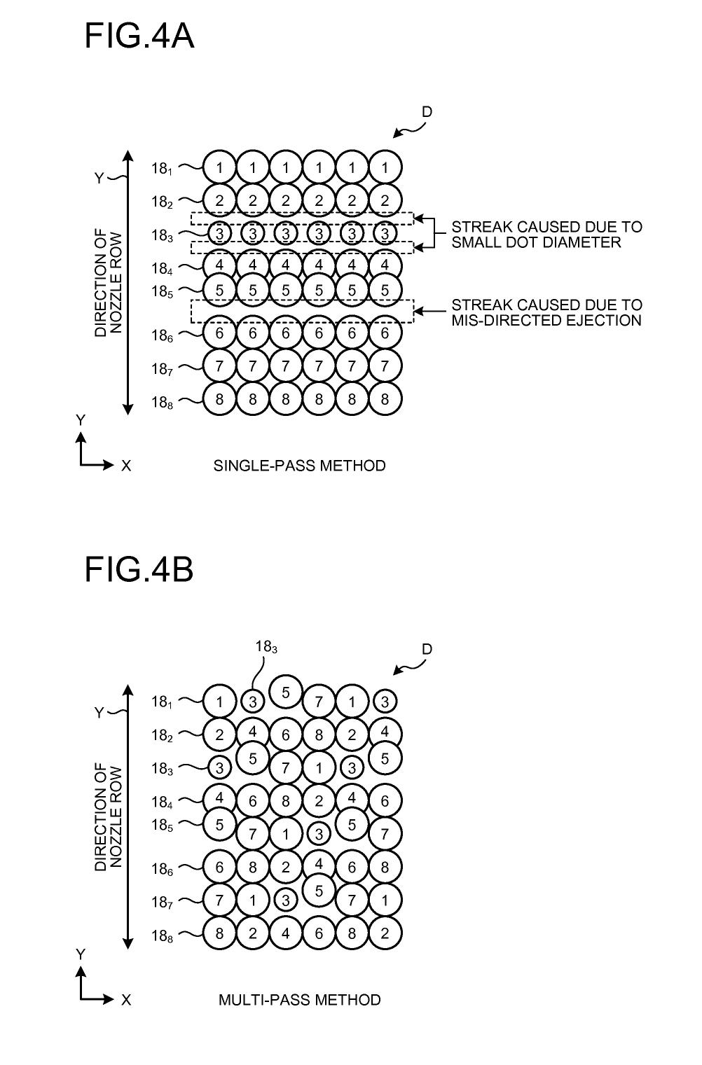

FIGS. 4A and 4B are explanatory diagrams of conventional images. Each of the images illustrated in FIGS. 4A and 4B is an example of a single-layer image containing one layer of the dots D.

FIG. 4A is a plan view of the XY plane of a conventional image recorded using the single-pass method. FIG. 4B is a plan view of the XY plane of a conventional image recorded using the multi-pass method. In FIGS. 4A and 4B, each of the numbers in the dots D indicates an identification number of the nozzle 18 used in recording the dots D. More specifically, for example, the number “1” in the dots D in FIGS. 4A and 4B indicates that the dots D are recorded using the nozzle 18₁, which is one of the plurality of nozzles 18₁ to 18₈ arranged in the first direction Y. Similarly, each of the numbers “2” to “8” in the dots D in FIGS. 4A and 4B indicates that the dots D are recorded using a corresponding one of the nozzles 18₂ to 18₈ of the plurality of nozzles 18₁ to 18₈ arranged in the first direction Y.

Assume that, as illustrated in FIGS. 4A and 4B, the amount of ink ejected from the nozzle 18₃, which is one of the plurality of nozzles 18₁ to 18₈ arranged in the first direction Y, is smaller than the other, normal nozzles 18 due to defective ejection or the like. Further assume that ink-ejecting direction of the nozzle 18₅, which is one of the plurality of nozzles 18₁ to 18₈ arranged in the first direction Y, is inclined toward the adjacent nozzle 18₄.

It is assumed that signals that cause the plurality of nozzles 18₁ to 18₈ to eject a same amount of ink are applied to driver elements (not shown) that drive the respective nozzles 18₁ to 18₈. It is assumed that the recording unit 14 is moved to perform a scan in the second direction X relative to the recording medium P, so that ink is ejected in order in the second direction X.

Under this condition, the diameter of the dots D recorded using the nozzle 18 (which is the nozzle 18₃ in FIGS. 4A and 4B) that ejects the smaller amount of ink is smaller than those of the other nozzles (which are the nozzle 18₁, 18₂, and 18₄ to 18₈ in FIGS. 4A and 4B).

Accordingly, when an image is formed by the single-pass method, an area of the dots D recorded using the nozzle 18₃ visually appears as streak extending along the second direction X as illustrated in FIG. 4A. Furthermore, the dots D of ink ejected from the nozzle 18₅ are recorded at positions closer to the dots D of ink ejected from the nozzle 18₄ produce streak extending along the second direction X between the dots D recorded using the nozzle 18₅ and the dots D recorded using the nozzle 18₆.

In contrast, in the multi-pass method, as described earlier, the recording unit 14 is relatively moved the predetermined travel in the first direction Y each time a scan in the second direction X is performed (see FIG. 2B). In the multi-pass method, an image of one layer is formed by performing a scan a plurality of times in the second direction X. Accordingly, as illustrated in FIG. 4B, with the multi-pass method, the dots D are recorded with ink ejected from the nozzles 18 that are different along the second direction X.

Under the circumstances, conventionally, color unevenness and streak is reduced by using the multi-pass method in lieu of the single-pass method. However, such a conventional technique has a disadvantage that using the multi-pass method increases time required to form an image (hereinafter, “image forming time”).

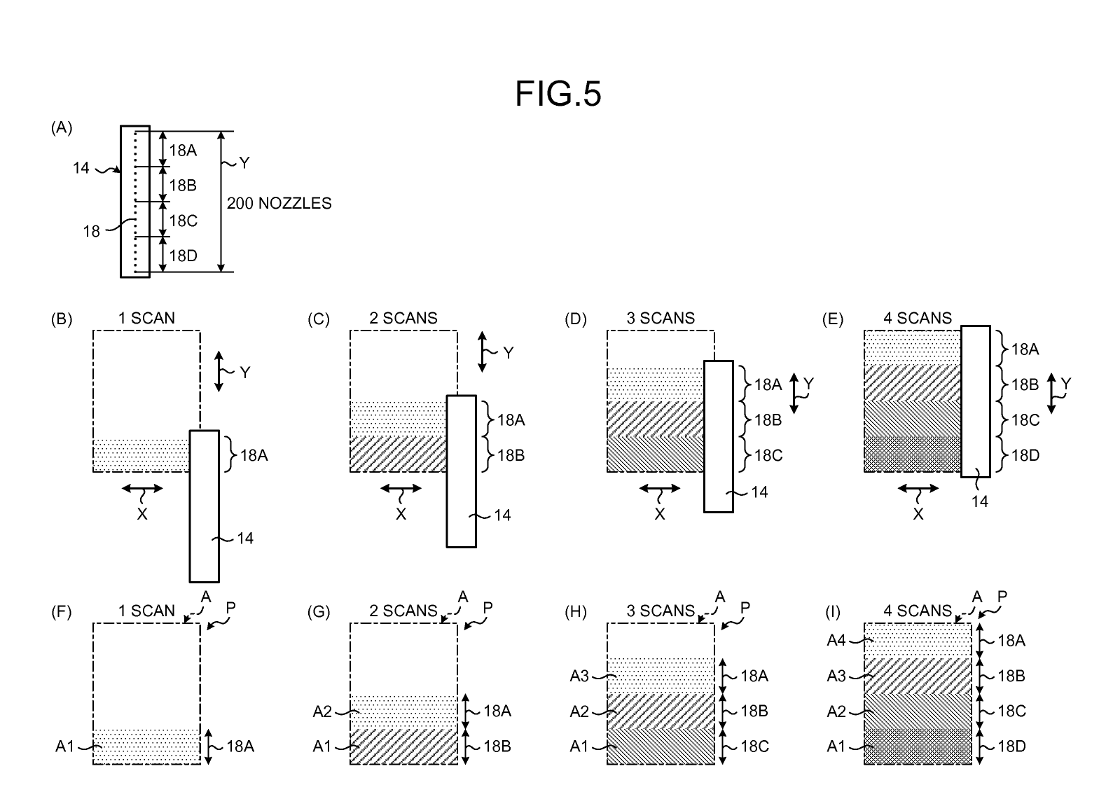

FIG. 5 is an explanatory diagram of how the recording unit 14 operates when forming a single-layer image of one layer using the multi-pass method.

FIG. 5 illustrates an example configuration of the recording unit 14 including an array of 200 nozzles as the nozzles 18 arranged in the first direction Y (see (A) of FIG. 5). In the example illustrated in FIG. 5, the plurality of nozzles 18 arranged in the first direction Y is divided into four groups each containing two or more of the nozzles 18 consecutively arranged in the first direction Y. More specifically, the plurality of nozzles 18₁ to 18₂₀₀ (the nozzles 18₁ to 18₂₀₀ are not specifically labeled in FIG. 5) arranged in the first direction Y is divided into a nozzle group 18A (the nozzles 18₁ to 18₅₀), a nozzle group 18B (the nozzles 18₅₁ to 18₁₀₀), a nozzle group 18C (the nozzles 18₁₀₁ to 18₁₅₀), and a nozzle group 18D (the nozzles 18₁₅₁ to 18₂₀₀). Each time the recording unit 14 is moved to perform a scan in the second direction X, the recording unit 14 is relatively moved a travel, which corresponds to each of the nozzle groups (18A to 18D), in the first direction Y.

More specifically, in the first scan in the second direction X performed by the recording unit 14, ink is ejected from each of the nozzles 18₁ to 18₅₀ belonging to the nozzle group 18A of the recording unit 14 (see (B) of FIG. 5). In this one scan, dots are recorded in an area A1 in a recording area A of the recording medium P (see (F) of FIG. 5). Thereafter, the recording unit 14 is relatively moved a travel corresponding to the 50 nozzles 18 in the first direction Y. In the second scan performed by the recording unit 14, ink is ejected from each of the nozzles 18₁ to 18₅₀ belonging to the nozzle group 18A and the nozzles 18₅₁ to 18₁₀₀ belonging to the nozzle group 18B of the recording unit 14 (see (C) of FIG. 5). This second scan places the area A1 in the recording area A of the recording medium P in a scanned-twice state and an area A2 in a scanned-once state (see (G) of FIG. 5).

The recording unit 14 is further relatively moved the travel corresponding to the 50 nozzles 18 in the first direction Y. In the third scan performed by the recording unit 14, ink is ejected from each of the nozzles 18₁ to 18₅₀ belonging to the nozzle group 18A, the nozzles 18₅₁ to 18₁₀₀ belonging to the nozzle group 18B, and the nozzles 18₁₀₁ to 18₁₅₀ belonging to the nozzle group 18C of the recording unit 14 (see (D) of FIG. 5). This third scan places the area A1 in the recording area A of the recording medium P in a scanned-three-times state, the area A2 in a scanned-twice state, and an area A3 in a scanned-once state (see (H) of FIG. 5).

The recording unit 14 is further relatively moved the travel corresponding to the 50 nozzles 18 in the first direction Y. In the fourth scan performed by the recording unit 14, ink is ejected from each of the nozzles 18₁ to 18₅₀ belonging to the nozzle group 18A, the nozzles 18₅₁ to 18₁₀₀ belonging to the nozzle group 18B, the nozzles 18₁₀₁ to 18₁₅₀ belonging to the nozzle group 18C, and the nozzles 18₁₅₁ to 18₂₀₀ belonging to the nozzle group 18D of the recording unit 14 (see (E) of FIG. 5). This fourth scan places the area A1 in the recording area A of the recording medium P in a scanned-four-times state, the area A2 in the recording area A of the recording medium P in a scanned-three-times state, the area A3 in a scanned-twice state, and an area A4 in a scanned-once state (see (I) of FIG. 5).

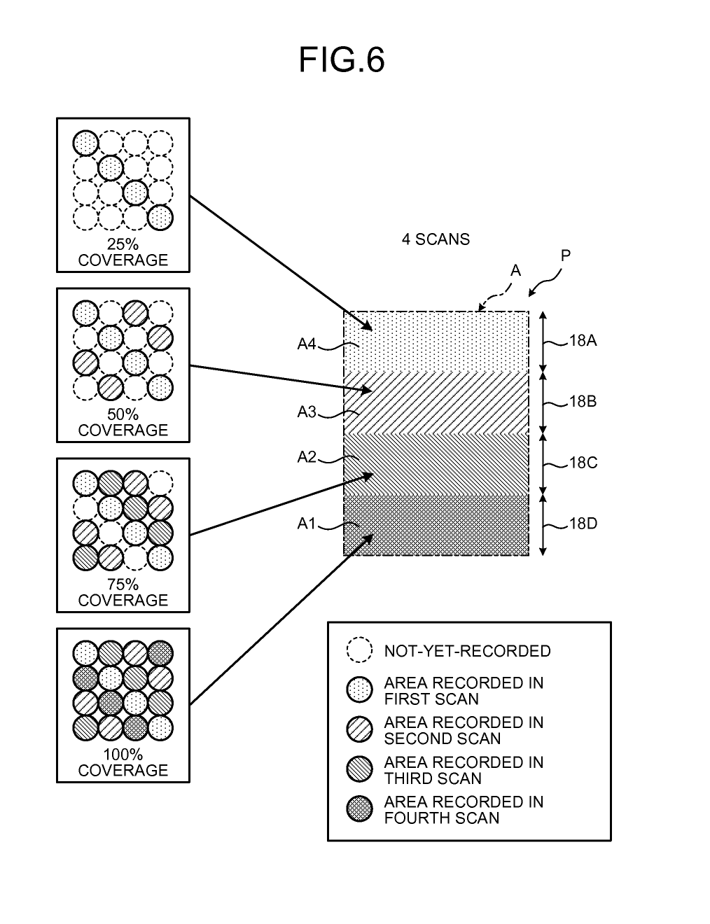

FIG. 6 is a diagram illustrating an example of the recording area A of the recording medium P scanned four times in the second direction X.

Assume that, as described earlier with reference to FIG. 5, the plurality of nozzles 18 provided on the recording unit 14 is divided into the four nozzle groups (18A to 18D) each containing the two or more nozzles 18 consecutively arranged in the first direction Y; the recording unit 14 is moved in the first direction Y the travel corresponding to each of the nozzle groups (18A to 18D). Under this condition, as illustrated in FIG. 6, the recording unit 14 that uses the multi-pass method records dots on each of the areas A1 to A4 in the recording area A of the recording medium P with 25% coverage in each scan in the second direction X.

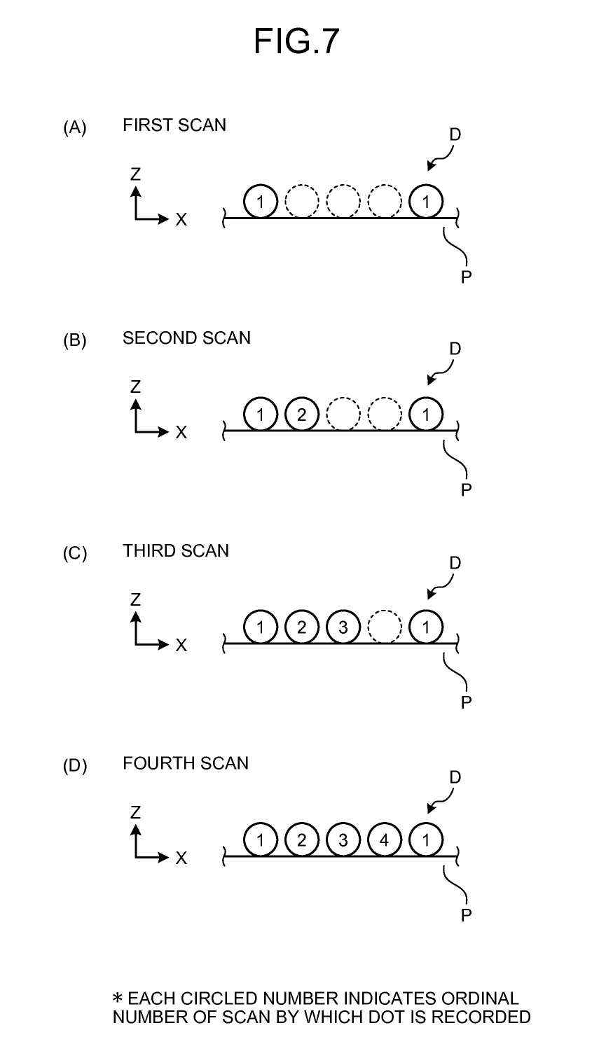

FIG. 7 is an explanatory diagram of coverages of the recording medium P on which an image of one layer is formed using conventional print data.

FIG. 7 illustrates an example in which the image is formed using the multi-pass method. In FIG. 7, the number in each of the dots D indicates the ordinal number of a scan in which the dot D is recorded. More specifically, for example, the number “1” in the dots D in FIG. 7 indicates that the dots D are recorded in the first scan in the second direction X. Similarly, each of the numbers “2” to “4” in the dots D in FIG. 7 indicates that the dots D are recorded in a corresponding one of the second to fourth scans in the second direction X.

As illustrated in FIG. 7, in the multi-pass method, an image of one layer is formed through a scan performed a plurality of times by the recording unit 14 in the second direction X. For instance, the recording unit 14 records the dots D in an area, which is a part of the recording medium P, in each scan in the second direction X. In the example illustrated in FIG. 7, as illustrated in (A) to (D) of FIG. 7, the image of one layer is formed by recording the dots D in order on the recording medium P by performing four scans in the second direction X (see (D) of FIG. 7).

Thus, the conventional technique that uses the multi-pass method simply in lieu of the single-pass method disadvantageously involves longer image forming time.

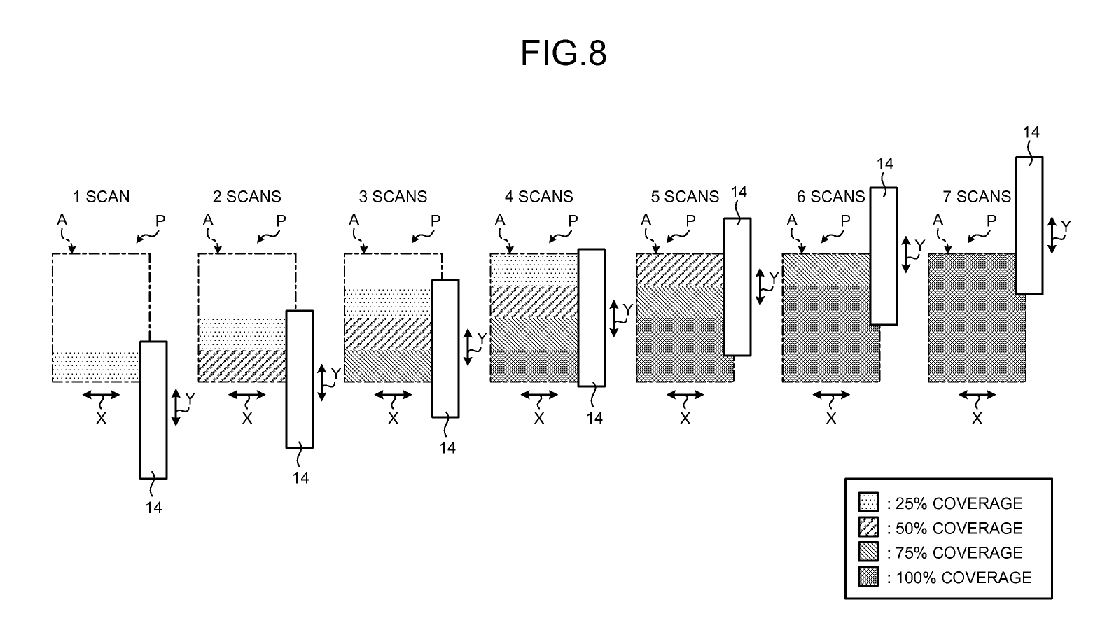

The image forming time is described more specifically below. FIG. 8 is an explanatory diagram of an example of a scan in the second direction X performed a plurality of times. Assume that, as described earlier with reference to FIG. 5, the plurality of nozzles 18 provided on the recording unit 14 is divided into the four nozzle groups (18A to 18D) each containing the two or more nozzles 18 consecutively arranged in the first direction Y; the recording unit 14 is moved in the first direction Y the travel corresponding to each of the nozzle groups (18A to 18D) each time a scan in the first direction Y is performed. Under this condition, as illustrated FIG. 8, seven scans in the second direction X are required to record the dots D that achieve 100% coverage across the entire area of the recording area A of the recording medium P.

Furthermore, when forming a multi-layer image by stacking the dots D, the number of scans to be performed in the first direction Y increases with the number of the layers. For instance, to form a multi-layer image of 10 layers using the multi-pass method, the recording unit 14 is required to repeatedly perform a scan 70 times in the second direction X.

As described above, the conventional technique is disadvantageous in that, when forming a multi-layer image by stacking the plurality of dots D using the multi-pass method, image forming time increases with the number of the layers. Thus, it has conventionally been difficult to reduce degradation in image quality caused by color unevenness, streak, or the like while achieving reduction in image forming time for a multi-layer image.

However, referring back to FIG. 3, the generation unit 12C of the image processing apparatus 12 of the first embodiment includes the first generator 12H.

The first generator 12H generates the first print data. The first print data has already been described earlier.

More specifically, the first generator 12H generates, from multi-layer image data, the first print data that satisfies the first condition. The first condition is that dots corresponding to pixels on different layers of a multi-layer image are to be recorded on a same recording area of the recording medium P in each of the second and subsequent scans performed.

To be more specific, the first generator 12H generates the first print data in which the nozzles 18, each for recording a dot corresponding to a pixel, are assigned to pixels on each layer of the multi-layer image data so as to satisfy the first condition.

The first generator 12H generates the first print data in the following manner.

The first generator 12H reads multi-layer image data converted by the converter 12G. As described earlier, the multi-layer image data converted by the converter 12G is data in which the nozzles 18, each for recording the dot D, are assigned to respective pixels included in the image data associated with the respective layer indicator information.

The first generator 12H determines, for each scan to be performed by the recording unit 14 in the second direction X, to which layer each pixel for recording a to-be-ejected dot of the read multi-layer image data belongs. At this time, the first generator 12H determines layers where pixels corresponding to dots to be recorded in one scan in the second direction X belong on a per-pixel-position basis so that the first condition is satisfied.

More specifically, firstly, the first generator 12H assigns the nozzles 18, each for recording the dot D corresponding to a pixel, to pixels to be recorded in the first scan performed on a recording area along the second direction X on the recording medium P. At this time, the first generator 12H selects pixels on the layer closest to the recording medium P (i.e., the lowermost layer) among pixels of pixel rows lying along the second direction X and corresponding to the recording area of the multi-layer image data as pixels to be recorded in the first scan. The first generator 12H assigns, to each of the selected pixels to be recorded in the first scan, one of the nozzles 18 for use in recording.

The first generator 12H determines, for each of the second and subsequent scans performed on the same recording area of the recording medium P, a pixel adjacent from above to a pixel recorded in a preceding scan as a pixel to be recorded in the next scan. More specifically, the first generator 12H selects a not-yet-recorded pixel adjacent to the already-recorded pixel from above as a pixel to be recorded in the next scan. The first generator 12H then assigns, to each of the thus-selected pixels, one of the nozzles 18 for use in recording.

Pixel locations of pixels selected as pixels to be recorded in each scan can be selected as desired. Therefore, higher reduction in printing time for forming a multi-layer image can be achieved as the number of pixels to be selected as the pixels to be recorded per scan increases.

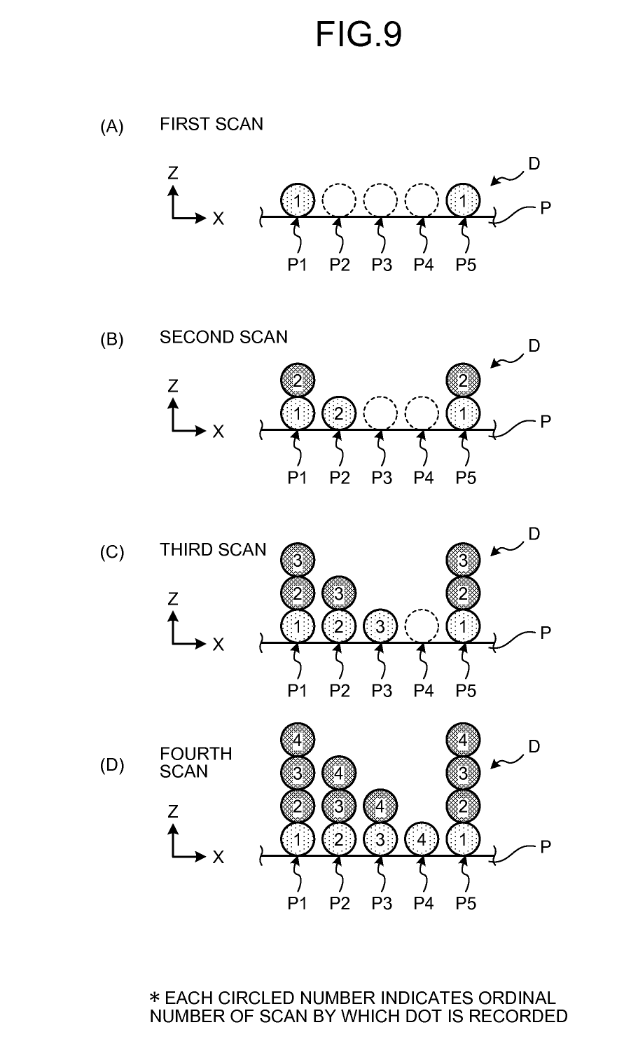

FIG. 9 is a schematic diagram illustrating the dots D recorded on the recording medium P by the recording unit 14 using the first print data generated by the first generator 12H.

In FIG. 9, the number in each of the dots D indicates the ordinal number of a scan by which the dot D is recorded. More specifically, for example, the number “1” in the dots D in FIG. 9 indicates that the dots D are recorded in the first scan in the second direction X. Similarly, each of the numbers “2” to “4” in the dots D in FIG. 9 indicate that the dots D are recorded in a corresponding one of the second to fourth scans in the second direction X.

In the first embodiment, the recording unit 14 records the dots D on the recording medium P using the first print data generated by the first generator 12H.

More specifically, for instance, in the first embodiment, as with the conventional method (see (A) of FIG. 7), the recording unit 14 records the dots D in an area, which is a part of the recording medium P, in the first scan in the second direction X (see (A) of FIG. 9). Referring to (A) of FIG. 9, the recording unit 14 records, in the first scan, the dots D corresponding to pixels on the first layer of the multi-layer image data at a position P1 and a position P5 among the positions P1 through P5 on the recording medium P along the second direction X.

The recording unit 14 records, in the second and subsequent scans in the second direction X, the dots D corresponding to pixels on different layers of the multi-layer image data in order.

For instance, as illustrated in (B) of FIG. 9, in the second scan, the recording unit 14 records the dots D corresponding to pixels on the second layer of the multi-layer image at the positions P1 and P5, at which the dots D belonging to the first layer have already been recorded, on the recording medium P among the positions P1 to P5 along the second direction X. In the second scan, the recording unit 14 also records the dot D corresponding to a pixel on the first layer of the multi-layer image at the position P2. The recording unit 14 performs recording in this manner using the first print data, thereby recording the dots D corresponding to pixels on different layers of the multi-layer image in one scan in the second direction X.

In the third scan, the recording unit 14 records the dots D corresponding to pixels on the third layer of the multi-layer image at the positions P1 and P5, at which the dots D belonging to the second layer have already been recorded, on the recording medium P among the positions P1 to P5 along the second direction X. The recording unit 14 also records the dot D corresponding to a pixel on the second layer of the multi-layer image at the position P2, at which the dot D of the first layer has already been recorded. The recording unit 14 also records the dot D corresponding to a pixel on the first layer of the multi-layer image at the position P3 (see (C) of FIG. 9).

In the fourth scan, the recording unit 14 records the dots D corresponding to pixels on the fourth layer of the multi-layer image at the positions P1 and P5, at which the dots D belonging to the third layer have already been recorded, on the recording medium P among the positions P1 to P5 along the second direction X. The recording unit 14 also records the dot D corresponding to a pixel on the third layer of the multi-layer image at the position P2, at which the dot D in the second layer has already been recorded. The recording unit 14 also records the dot D corresponding to a pixel on the second layer of the multi-layer image at the position P3, at which the dot D belonging to the first layer has already been recorded. The recording unit 14 records the dot D corresponding to a pixel on the first layer of the multi-layer image at the position P4 (see (D) of FIG. 9).

Thus, according to the first embodiment, the recording unit 14 ejects ink in accordance with the first print data, thereby recording the dots D corresponding to pixels on different layers of the multi-layer image in one scan in the second direction X. Put another way, in contrast to ink ejection in accordance with the conventional print data (see FIG. 7), the first embodiment allows recording the dots D belonging to the plurality of layers by performing the same number (four) of scans in the second direction X as illustrated in FIG. 9.

Thus, the first embodiment allows achieving both of reducing degradation in image quality caused by color unevenness, streak, or the like and reducing image forming time for a multi-layer image.

Meanwhile, recording the dots D corresponding to pixels at a same pixel location using a same one of the nozzles 18 in the pixel-stacking direction can make the surface of the image uneven. Such surface unevenness can be visually recognized as streak or color unevenness in the image.

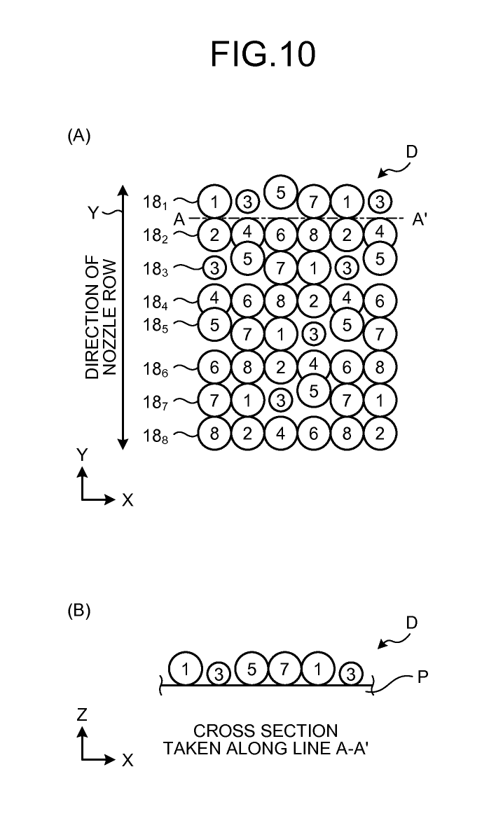

FIG. 10 illustrates surface unevenness of a single-layer image.

In FIG. 10, (A) is a plan view of the XY plane of a single-layer image of one layer formed using the multi-pass method; (B) is a cross-sectional view of (A) taken along line A-A′.

In FIG. 10, each of the numbers in the dots D indicates an identification number of the nozzle 18 used in recording the dots D. More specifically, for example, each of the numbers “1” to “8” in the dots D in FIG. 10 indicates that the dots D are recorded using a corresponding one of the plurality of nozzles 18₁ to 18₈ arranged in the first direction Y.

Assume that, as illustrated in (A) of FIG. 10, the amount of ink ejected from the nozzle 18₃, which is one of the plurality of nozzles 18₁ to 18₈ arranged in the first direction Y, is smaller than the other, normal nozzles 18 due to defective ejection or the like. Further assume that ink-ejecting direction of the nozzle 18₅, which is one of the plurality of nozzles 18₁ to 18₈ arranged in the first direction Y, is inclined toward the nozzle 18₄ adjacent to the nozzle 18₅ in the first direction Y.

It is assumed that signals that cause a same amount of ink to be ejected are applied to the driver elements (not shown) that respectively drive the nozzles 18₁ to 18₈. It is assumed that the recording unit 14 is moved to perform a scan in the second direction X relative to the recording medium P, so that ink is ejected in the second direction X in order.

Under this condition, the diameter of the dots D recorded using the nozzle 18 (which is the nozzle 18₃ in FIG. 10) that ejects a smaller amount of ink is smaller than those of the other nozzles (which are the nozzle 18₁, 18₂, and 184 to 18₈ in FIG. 10).

As described earlier with reference to FIG. 4B, in the multi-pass method, the dots D are recorded with ink ejected from the nozzles 18 that are different along the second direction X (see (A) of FIG. 10). Accordingly, the multi-pass method can reduce color unevenness or streak in an image as compared with the single-pass method. However, when the nozzles 18 vary in the ejection amount, unevenness develops on the surface of a resultant single-layer image of one layer.

When a multi-layer image is formed by stacking dots such that dots corresponding to pixels at a same pixel location are recorded using a same one of the nozzles 18, surface unevenness of the multi-layer image increases with the number of the layers.

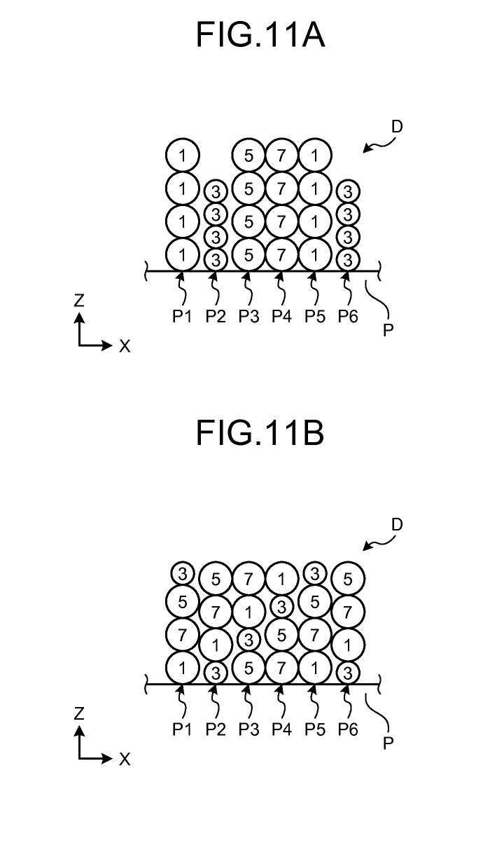

FIGS. 11A and 11B are cross-sectional diagrams taken along the vertical direction Z each illustrating an example of a multi-layer image. As in (A) and (B) of FIG. 10, each of the numbers in the dots D indicates an identification number of the nozzle 18 used in recording the dots D in FIGS. 11A and 11B.

FIG. 11A is a cross-sectional diagram of a multi-layer image formed by stacking dots such that dots corresponding to pixels at a same pixel location are recorded using a same one of the nozzles 18. As illustrated in FIG. 11A, when dots at each of the positions P1 to P6 on the recording medium P along the second direction X are recorded using a same one of the nozzles 18, surface unevenness of the multi-layer image increases with the number of the layers.

Accordingly, referring back to FIG. 3, it is desirable that the generation unit 12C further includes the second generator 12I. Although an example in which the generation unit 12C includes the second generator 12I is described in the first embodiment, the generation unit 12C does not necessarily include the second generator 12I. However, it is desirable that the generation unit 12C includes the second generator 12I.

The second generator 12I generates, from multi-layer image data, second print data that satisfies a second condition. The second condition is that different ones of the nozzles 18 are to be used in recording the dots D corresponding to pixels on different layers of the multi-layer image data at a same pixel location. The second print data is print data in which the nozzles 18, each for recording the dot D corresponding to a pixel, are assigned to respective pixels on each layer of the multi-layer image data so as to satisfy the second condition.

More specifically, the second generator 12I reads multi-layer image data converted by the converter 12G first. As described earlier, the multi-layer image data converted by the converter 12G is data in which the nozzles 18, each for recording the dot D, are assigned to respective pixels included in each of the image data associated with the respective layer indicator information.

The second generator 12I changes allocation of the nozzles 18 assigned to the pixels of the multi-layer image data so as to satisfy the second condition that different ones of the nozzles 18 are to be used in recording the dots D corresponding to pixels on different layers at a same pixel location. The second generator 12I generates the second print data from multi-layer image data in this manner.

The second generator 12I changes the allocation in the following manner. For instance, the second generator 12I changes the allocation of the nozzles 18 so that the nozzles 18 assigned to record the dots D corresponding to pixels at a same pixel location in the multi-layer image data are shifted, between each layers, a predetermined distance in the direction (the first direction Y) in which the array of the plurality of nozzles 18 is arranged.

The direction (hereinafter, “shifting direction”) in which the allocation is to be shifted and the distance over which the allocation is to be shifted are preferably adaptively set depending on a print condition. Examples of the print condition include printing resolution, printing orientation of the recording medium P, and printing speed. More specifically, for example, the distance over which the allocation is to be shifted may be reduced as the printing resolution increases. For another example, the distance over which the allocation is to be shifted may be increased with the printing speed; the distance over which the allocation is to be shifted may be reduced as the printing speed decreases. The shifting direction of the allocation may be both the first direction Y along which the array of the plurality of nozzles 18 is arranged and the second direction X or, alternatively, any one of these directions.

FIG. 11B is an example of a cross-sectional diagram of a multi-layer image formed with ink ejected by the recording unit 14 in accordance with the second print data. When the dots D corresponding to pixels on different layers at a same pixel location are recorded using different ones of the nozzles 18 (see FIG. 11B), surface unevenness of a multi-layer image is reduced as compared with an image formed by recording the dots D corresponding to pixels on different layers at a same pixel location using a same one of the nozzles 18 (see FIG. 11A). As a result, degradation in image quality caused by unevenness can be reduced.

With the configuration in which the generation unit 12C includes the second generator 12I, the first generator 12H may preferably generate the first print data from the second print data generated by the second generator 12I.

Hence, according to the first embodiment, the first print data is print data that satisfies both the first condition and the second condition.

Forming, by the recording unit 14, a multi-layer image using the first print data generated by the first generator 12H allows achieving both reduction in degradation in image quality and reduction in image forming time even when the number of layers of the multi-layer image is large.

An example in which the second generator 12I changes, between each layers, the allocation of the nozzles 18 assigned to pixels of every pixel row in the direction (the first direction Y) in which the array of the plurality of nozzles 18 is arranged of the multi-layer image data has been described above. Alternatively, the second generator 12I may change, between the layers, the allocation of the nozzles 18 assigned to the pixels of one or more of the plurality of pixel rows in the direction in which the array of the plurality of nozzles 18 is arranged of the multi-layer image data.

The second generator 12I may store allocation information, in which allocation varying from one to another of the layers is randomly defined, in the storage unit 12E in advance. For instance, the calculation unit 12F may calculate the allocation information, in which allocation varying from one to another of the layers is randomly defined, in advance and store the allocation information associated with information indicating the layers in the storage unit 12E. The calculation unit 12F may calculate the allocation information for each of the layers using random dither, for example. As the allocation information, assignment patterns of the nozzles 18 associated with print conditions may be stored in the storage unit 12E in advance. The assignment patterns of the nozzles 18 may be given using, for example, a table in which assignments of the nozzles 18 are randomly arranged.

The second generator 12I reads out, for each of the layers of the multi-layer image data, allocation information corresponding to the layer from the storage unit 12E. Alternatively, the second generator 12I may read out allocation information associated with a print condition from the storage unit 12E. The second generator 12I may change the allocation of the nozzles 18 assigned to respective pixels using the read-out allocation information on a per-layer basis.

The output unit 12D outputs the print data (the first print data or the third print data) generated by the generation unit 12C to the recording apparatus 30.

The recording apparatus 30 includes the recording unit 14, a recording controller 28, the driver 26, and the irradiator 20. The recording unit 14, the driver 26, and the irradiator 20 are described above, and therefore description thereof is omitted below.

The recording controller 28 accepts the print data from the image processing apparatus 12. When the accepted print data is the third print data which is single-layer image data, the recording controller 28 controls the recording unit 14, the driver 26, and the irradiator 20 so as to record dots corresponding to respective pixels by causing the nozzles 18 assigned to the pixels to eject ink for the pixels. When the accepted print data is the first print data which is multi-layer image data, the recording controller 28 controls the recording unit 14, the driver 26, and the irradiator 20 so as to record dots corresponding to respective pixels of the image data of each layer by causing the nozzles 18 assigned to the pixels to eject ink for the pixels in each scan in the second direction X.

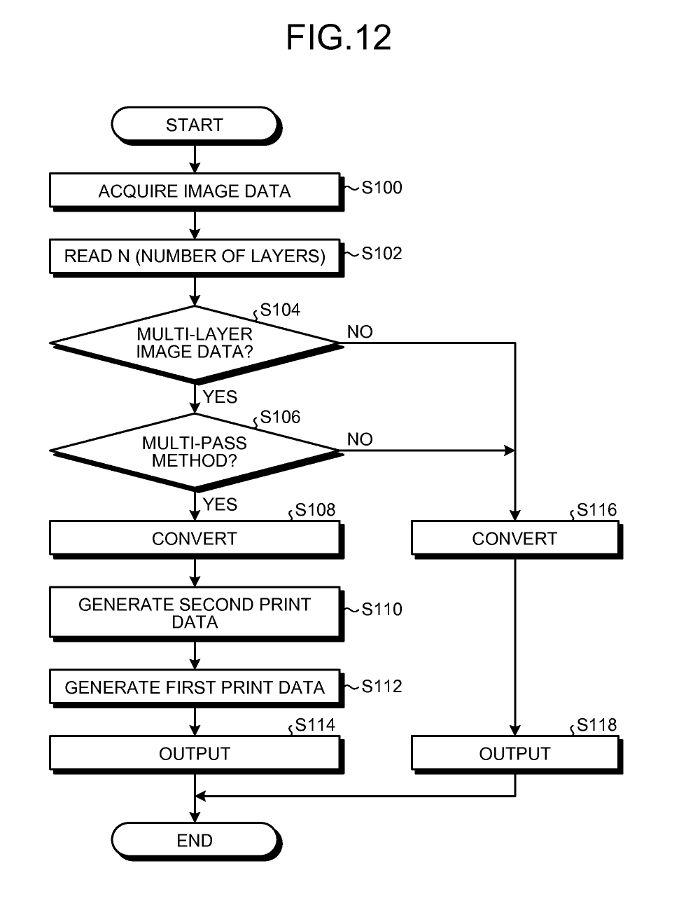

A routine for image processing to be performed by the main control unit 13 of the image processing apparatus 12 is described below. FIG. 12 is a flowchart of the routine for image processing to be performed by the main control unit 13.

The acquisition unit 12A acquires image data from an external device or the like (not shown) first (step S100). Thereafter, the determination unit 12B reads N, the number of image layers, of the image data acquired at step S100 (step S102).

Thereafter, the determination unit 12B determines whether or not the image data acquired at step S100 is multi-layer image data (step S104). If the image data is multi-layer image data (Yes at step S104), the determination unit 12B determines whether or not the recording unit 14, from which the image is to be output, uses the multi-pass method (step S106). For instance, the acquisition unit 12A may transmit a signal inquiring about a recording method used by the recording unit 14 to the recording apparatus 30, from which the image is to be output (hereinafter, “output-target recording apparatus 30”). The output-target recording apparatus 30 may be the recording apparatus 30 connected to the image processing apparatus 12 or the recording apparatus 30 designated by the external device (not shown) as an apparatus from which the image is to be output. The acquisition unit 12A receives a signal indicating the recording method from the recording apparatus 30. The determination unit 12B makes the determination at step S106 by reading the received signal indicating the recording method.

If the recording method used by the recording unit 14 of the output-target recording apparatus 30 is the multi-pass method (Yes at step S106), processing proceeds to step S108.

At step S108, the converter 12G converts the multi-layer image data acquired at step S100 into raster image data (step S108). More specifically, the converter 12G converts image data of each layer contained in the multi-layer image data acquired at step S100 into raster image data and applies, as initial assignment, a predetermined assignment of the nozzles 18, each for recording the dot D corresponding to a pixel, to respective pixels in the image data of the each layer.

Thereafter, the second generator 12I generates the second print data from the multi-layer image data converted at step S108 (step S110).

Thereafter, the first generator 12H generates the first print data from the second print data generated at step S110 (step S112).

Thereafter, the output unit 12D outputs the first print data generated at step S112 to the output-target recording apparatus 30 (step S114). Then, the routine ends.

In the recording apparatus 30 that has received the first print data, the recording controller 28 controls the recording unit 14, the irradiator 20, and the driver 26 in accordance with the first print data. As a result, a multi-layer image is formed on the recording medium P.

If the determination made at step S104 is negative (No at step S104), processing proceeds to step S116. If the determination made at step S106 is negative (No at step S106), processing proceeds to step S116.

At step S116, the converter 12G converts the image data acquired at step S100 into raster image data (step S116).

Thereafter, the output unit 12D outputs the image data converted at step S116 to the output-target recording apparatus 30 as the third print data (step S118). Then, the routine ends.

As described above, the image processing apparatus 12 of the first embodiment includes the acquisition unit 12A and the generation unit 12C.

The acquisition unit 12A acquires image data representing a multi-layer image. The recording unit 14 forms the multi-layer image. The recording unit 14 includes the plurality of nozzles 18 that records the dots D by ejecting droplets. The plurality of nozzles 18 are arranged in an array in the first direction Y. The recording unit 14 is moved to perform a scan in the second direction X intersecting the first direction Y. Each time the recording unit 14 is moved to perform a scan in the second direction X, the recording unit 14 is moved in the first direction Y relative to the recording medium P. The first generator 12H generates, from the multi-layer image data, the first print data that satisfies the first condition. The first condition is that dots corresponding to pixels on different layers of the multi-layer image are to be recorded in each of the second and subsequent scans performed on a same recording area of the recording medium P.

The image processing apparatus 12 of the first embodiment generates the first print data for use by the recording unit 14 that records a multi-layer image using the multi-pass method in this manner. The recording unit 14 forms the multi-layer image using the multi-pass method in accordance with the first print data. Accordingly, degradation in image quality caused by color unevenness, streak, or the like can be reduced.

Furthermore, the first print data is print data that satisfies the first condition. Forming the multi-layer image in accordance with the first print data allows the recording unit 14 to record the dots D corresponding to pixels on a plurality of layers simultaneously through the same number of scans as the number of scans conventionally required to form an image of one layer. Accordingly, the image processing apparatus 12 of the first embodiment can reduce image forming time for a multi-layer image.

Hence, the image processing apparatus 12 of the first embodiment can provide print data that allows achieving both of reducing degradation in image quality caused by color unevenness, streak, or the like and reducing image forming time for a multi-layer image.

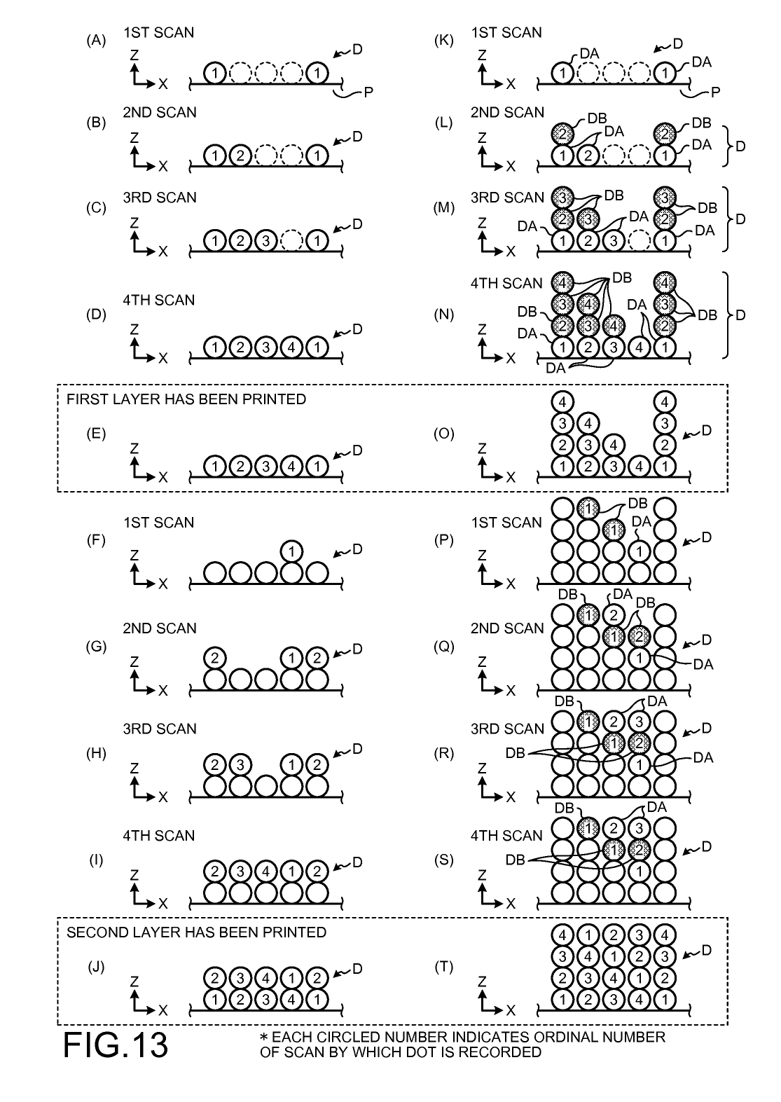

FIG. 13 is an explanatory diagram of how the recording unit 14 forms a multi-layer image using the first print data generated by the image processing apparatus 12 of the first embodiment.

In FIG. 13, (A) to (J) illustrate how a multi-layer image of two layers is formed from conventional print data using the multi-pass method. In FIG. 13, (K) to (T) illustrate how a multi-layer image is formed from the first print data of the first embodiment using the multi-pass method.

In FIG. 13, the number in each of the dots D indicates the ordinal number of a scan by which the dot D is recorded. More specifically, each of the numbers “1” to “4” in the dots D in FIG. 13 indicates that the dots D are recorded in a corresponding one of the first to fourth scans in the second direction X.

A multi-layer image using conventional print data is formed in the following manner, for example. An image of one layer is formed by performing four scans, in each of which the dots D are recorded on the recording medium P, in the second direction X in order (see (A) to (E) of FIG. 13). Thereafter, an image of the second layer is formed by performing four scans in the second direction X on the same recording area as the first scan on the recording medium P (see (F) to (J) of FIG. 13). Thus, the multi-layer image of two layers is formed from the conventional print data by repeatedly performing the scan in the second direction X eight times in total on the same recording area of the recording medium P.

However, as described earlier, a multi-layer image using the first print data of the first embodiment is formed by recording the dots D corresponding to pixels on different layers of the multi-layer image in each of the second and subsequent scans performed on a same recording area of the recording medium P.

Accordingly, the first embodiment allows forming a multi-layer image of four layers through the same number of scans as the number of scans to be performed to form a multi-layer image of two layers using conventional print data.

More specifically, when the dots D are recorded using the first print data generated according to the first embodiment, a multi-layer image of four layers can be formed (see (T) of FIG. 13) through eight scans performed by the recording unit 14 in the second direction X (see (K) to (S) of FIG. 13).

This will be described in detail below. In formation of a multi-layer image on the recording medium P using conventional print data using the multi-pass method, the dots D corresponding to pixels on one layer of the multi-layer image are recorded in one scan in the second direction X. Put another way, conventionally, by one scan in the second and subsequent scans in the second direction X, the dots D corresponding to pixels on the same layer as that of the preceding scan of the multi-layer image are recorded in an area where the dot D is not recorded in the preceding scan in order (see (B) to (D) of FIG. 13).

However, in formation of a multi-layer image using the first print data generated in the first embodiment, the dots D corresponding to pixels on different layers of the multi-layer image are recorded in each scan performed in the second direction X by the recording unit 14. This will be described in detail below. According to the first embodiment, the dot D corresponding to a pixel on the same layer as that of a preceding scan is recorded in at least a portion of an area where the dot D is not recorded in the preceding scan in the second and subsequent scans in the second direction X performed on the same recording area of the recording medium P in order (see dots DA in (K) to (N) of FIG. 13). In addition, according to the first embodiment, in an area where the dot D is already recorded on the recording medium P in the preceding scan, the dot D corresponding to a pixel adjacent from above to a pixel corresponding to the already-recorded dot D in the multi-layer image is recorded (see dots DA of (L) to (N) of FIG. 13) at this time.

Accordingly, multi-layer image formation using the first print data of the first embodiment can reduce image forming time for a multi-layer image.

Furthermore, according to the first embodiment, a multi-layer image is formed using the multi-pass method. Accordingly, occurrence of color unevenness and streak can be reduced.

Hence, the image processing apparatus 12 of the first embodiment can generate print data that allows achieving both of reducing degradation in image quality and reducing image forming time for a multi-layer image.

Pixel locations and the number of pixels for which the dots D are to be recorded per scan in the second direction X may be set as desired. The number of the pixels for which the dots D are to be recorded per scan in the second direction X may be fixed or vary from one scan to another.

An example of forming a multi-layer image of four layers by using the first print data generated according to the first embodiment through the same number of scans as the number of scans to be performed to form a multi-layer image of two layers using conventional print data has been described with reference to FIG. 13. However, multi-layer images to be recorded using the first print data are not limited to multi-layer images of four layers. The first generator 12H can achieve further reduction in image forming time for a multi-layer image by adjusting the number of pixels to be recorded in one scan in the second direction X of the first print data. In short, higher reduction in image forming time for a multi-layer image can be achieved as the number of pixels to be recorded in one scan increases.

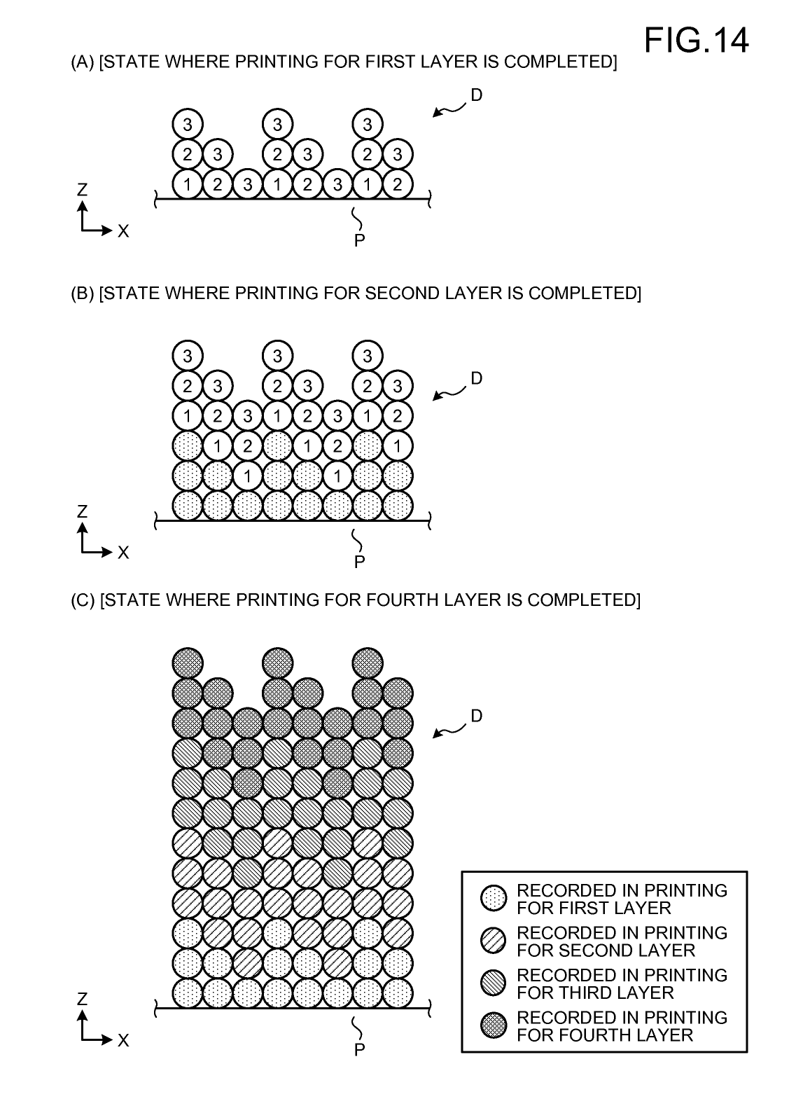

FIG. 14 is an explanatory diagram of forming a multi-layer image of ten layers by using the first print data generated according to the first embodiment through the same number of scans as the number of scans to be performed to form a multi-layer image of four layers using conventional print data.

In FIG. 14, the number in each of the dots D indicates the ordinal number of a scan in the second direction X by which the dot D is recorded to form an image of each layer using the conventional print data. More specifically, each of the numbers “1” to “4” in the dots D in FIG. 14 indicates that the dots D are recorded in a corresponding one of the first to fourth scans in the second direction X performed using the conventional print data one layer by one layer.

As illustrated in (A) of FIG. 14, according to the first embodiment, by recording the dots D using the first print data generated by the image processing apparatus 12 of the first embodiment, the dots D corresponding to pixels of an image of three layers are recorded through the same number of scans as the number of scans to be performed to form an image of one layer using conventional print data. As illustrated in (B) of FIG. 14, according to the first embodiment, by recording the dots D using the first print data generated by the image processing apparatus 12 of the first embodiment, the dots D corresponding to pixels of an image of six layers are recorded through the same number of scans as the number of scans to be performed to form an image of two layers using conventional print data.

As illustrated in (C) of FIG. 14, according to the first embodiment, by repeating a scan of recording the dots D using the first print data generated by the image processing apparatus 12 of the first embodiment, the dots D corresponding to pixels of an image of ten layers are recorded through the same number of scans as the number of scans to be performed to form an image of four layers using conventional print data.

Furthermore, according to the first embodiment, a multi-layer image is formed using the multi-pass method. Accordingly, occurrence of color unevenness and streak can be reduced.

Hence, the image processing apparatus 12 of the first embodiment can provide print data that allows achieving both of reducing degradation in image quality and reducing image forming time for a multi-layer image.

The generation unit 12C of the first embodiment preferably includes the second generator 12I and the first generator 12H. The second generator 12I generates, from multi-layer image data, the second print data that satisfies the second condition. The second condition is that different ones of the nozzles 18 are to be used in recording the dots D corresponding to pixels on different layers at a same pixel location. The second print data is print data in which the nozzles 18, each for recording the dot D corresponding to a pixel, are assigned to respective pixels on each layer of the multi-layer image data so as to satisfy the second condition. In the first embodiment, the first generator 12H generates the first print data from the second print data.

Generating the first print data from the second print data in which different ones of the nozzles 18, each for recording the dot D corresponding to a pixel, are assigned to pixels at a same pixel location allows reducing surface unevenness of the multi-layer image caused by the dots D ejected from one, which ejects ink defectively, of the nozzles 18 and stacked at a same pixel location.

Accordingly, the configuration in which the generation unit 12C includes the second generator 12I and the first generator 12H can provide, in addition to the advantage described above, print data that can reduce surface unevenness of the multi-layer image.

The image processing apparatus 12 of the first embodiment can increase surface smoothness of the multi-layer image with simple image processing.

The image processing apparatus 12 of the first embodiment can reduce variations in UV (ultraviolet) irradiation time in an image plane of the multi-layer image when ink containing photo-curable resin is used as the ink to be ejected.

### Modifications

The first generator 12H may be modified to generate first print data which satisfies the first condition and in which the difference in level (hereinafter, the “difference in layer level”) between layers, to which pixels corresponding to the dots D to be recorded in one scan in the second direction X belong, is equal to or smaller than a threshold.

The threshold for the difference in layer level is preferably adjusted so that the dots D of ink ejected from the nozzles 18 reach the recording medium P at positions within a range, deviation from which results in degradation in image quality. The threshold for the difference in layer level is preferably adjusted so that layers where ejected ink deposits are within the distance from the irradiator 20 that allows the irradiator 20 to properly harden the ink.

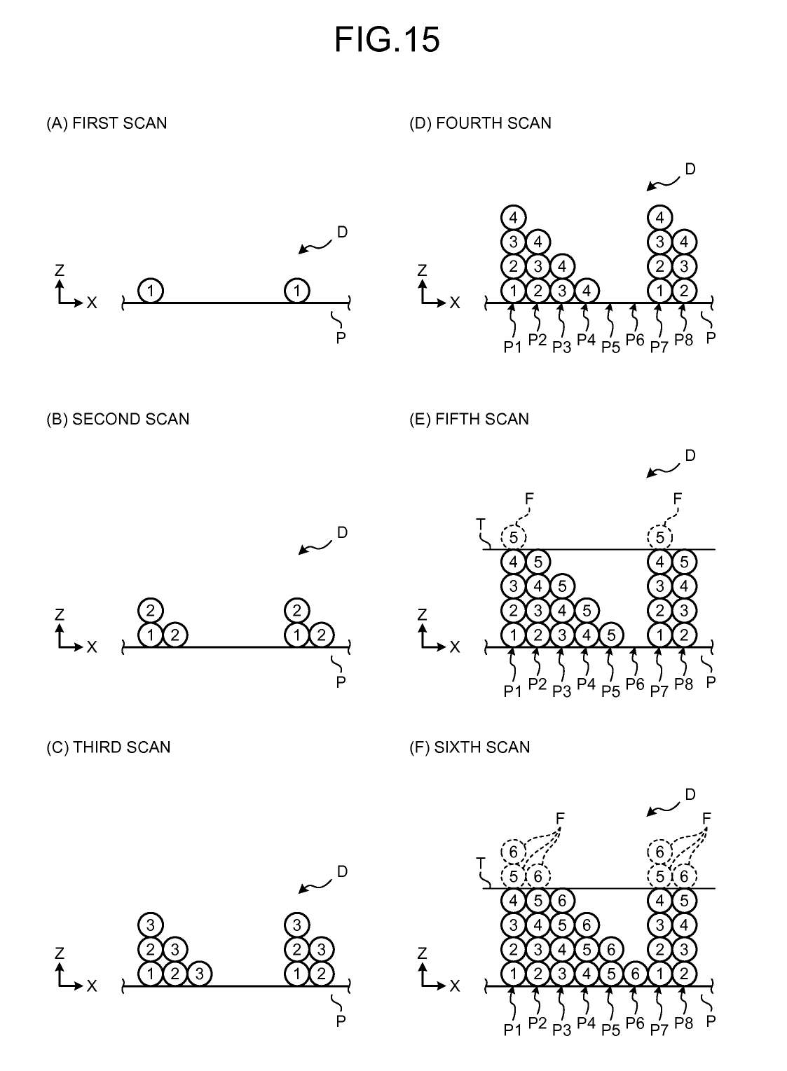

FIG. 15 is an explanatory diagram of how a multi-layer image is formed using the first print data generated by the first generator 12H of the modification. In FIG. 15, the number in each of the dots D indicates the ordinal number of a scan by which the dot D is recorded. More specifically, each of the numbers “1” to “6” in the dots D in FIG. 15 indicates that the dots D are recorded in a corresponding one of the first to sixth scans in the second direction X.

Assume that, for example, the generation unit 12C has generated the first print data with the threshold set to four layers. More specifically, assume that the generation unit 12C has generated the first print data so that the difference in level between layers, to which pixels corresponding to the dots D to be recorded in one scan in the second direction X belong, is equal to or smaller than four layers.

Under this condition, the multi-layer image illustrated in FIG. 15 may be formed by the recording unit 14 using the first print data generated by the generation unit 12C, for example.

This will be described in detail below. In the example illustrated in FIG. 15, the dots D are recorded on the recording medium P by the first to the fourth scans performed in order in the second direction X as in the first embodiment, more specifically such that the dots D corresponding to pixels on different layers of the multi-layer image are recorded in each of the second and subsequent scans (see (A) to (D) of FIG. 15).

In the example illustrated in FIG. 15, the fourth scan performed by the recording unit 14 brings the recording medium P to a state where the dots D are stacked in four layers in the areas P1 and P7 of the recording medium P as illustrated in (D) of FIG. 15. The dots D are not formed in the areas P5 and P6.

In the example illustrated in FIG. 15, the generation unit 12C has generated the first print data so that the difference in level between layers, to which pixels corresponding to the dots D to be recorded in one scan in the second direction X belong, is equal to or smaller than four layers.

Accordingly, in the fifth scan performed by the recording unit 14, the dots D are not additionally stacked in the areas P1 and P7 in the recording area (the areas P1 to P8 of FIG. 15) along the second direction X of the recording medium P (see reference symbol F in (E) of FIG. 15). In short, the dot D is not additionally stacked in an area where the dot D causes the difference in stacked height of the dots D to exceed four layers (see line T in (E) of FIG. 15). The dots D are stacked in the areas (the areas P2 to P6, and P8) excluding the areas P1 and P7.

In the sixth scan performed by the recording unit 14, the dots D are not additionally stacked in the areas P1, P7, P2, and P8 in the recording area (the areas P1 to P8 of FIG. 15) along the second direction X of the recording medium P (see reference symbol F in (F) of FIG. 15). In short, the dot D is not additionally stacked in an area where the dot D causes the difference in stacked height of the dots D to exceed four layers (see line T in (F) of FIG. 15). The dots D are stacked in the areas (the areas P3 to P6) excluding the areas P1, P2, P7, and P8.

As described above, in this modification, the generation unit 12C generates the first print data which satisfies the first condition and in which the difference in level between layers, to which pixels corresponding to the dots D to be recorded in one scan in the second direction X belong, is equal to or smaller than the threshold.

By setting a limit on the difference in level between layers, to which pixels to be recorded in one scan belong, in this manner allows reducing positional deviation on the recording medium P of the dots D recorded in one scan and uneven hardening of the dots D under irradiation with light emitted from the irradiator 20.

Accordingly, the modification not only provides the advantage provided by the first embodiment but also allows increasing image quality.

### Second Embodiment

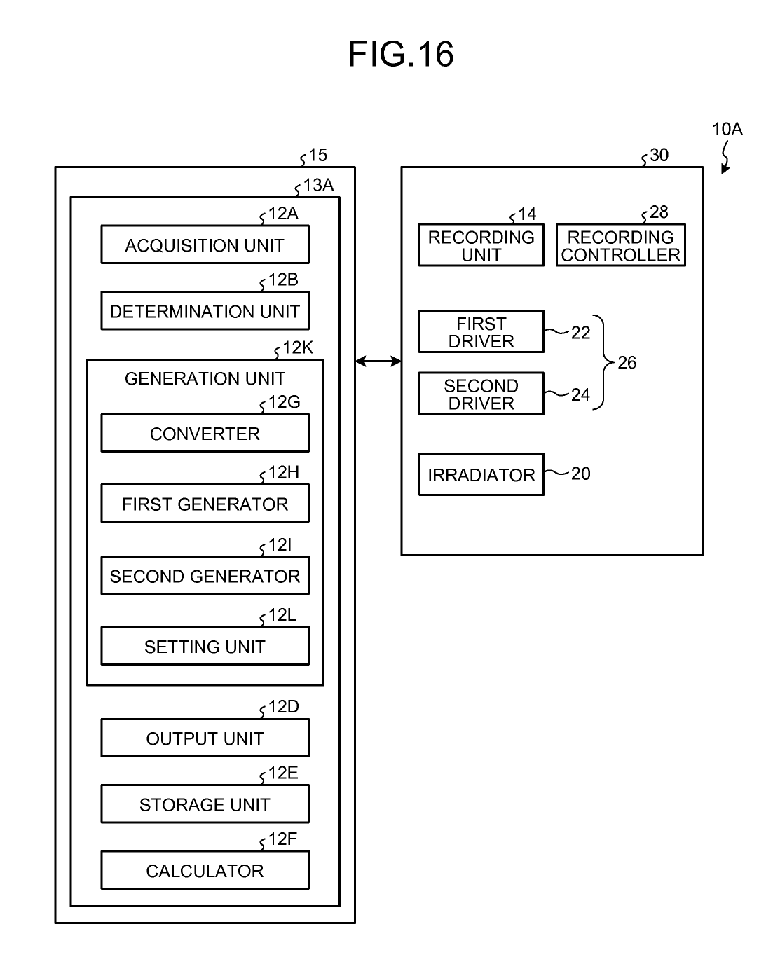

FIGS. 1 and 16 are diagrams illustrating an example of an image processing system 10A according to a second embodiment.

The image processing system 10A includes an image processing apparatus 15 and the recording apparatus 30. The recording apparatus 30 is similar to that of the first embodiment.

As illustrated in FIG. 16, the image processing apparatus 15 includes a main control unit 13A. The main control unit 13A is a computer including a CPU and the like and provides overall control of the image processing apparatus 15. The main control unit 13A may be configured without a general-purpose CPU. For instance, the main control unit 13A may be made up of a circuit and the like.

The main control unit 13A includes the acquisition unit 12A, the determination unit 12B, a generation unit 12K, the output unit 12D, the storage unit 12E, and the calculation unit 12F. Some or all of the acquisition unit 12A, the determination unit 12B, the generation unit 12K, the output unit 12D, and the calculation unit 12F may be implemented by causing a processing device such as the CPU to execute program instructions or, in short, by software or, alternatively, by hardware such as an IC or, further alternatively, by a combination of software and hardware.

The generation unit 12K includes the converter 12G, the first generator 12H, the second generator 12I, and a setting unit 12L. The generation unit 12K is similar to the generation unit 12C of the first embodiment (see FIG. 3) except for additionally including the setting unit L.

The setting unit 12L adaptively sets the number of scans in the second direction X to be performed by the recording unit 14 on a same recording area of the recording medium P depending on a print condition.

Examples of the print condition include, as in the first embodiment, printing resolution and printing speed. More specifically, for example, the setting unit 12L may set the number of scans such that the higher the printing resolution, the larger the number of scans in the second direction X to be performed on the same recording area of the recording medium P. For another example, the setting unit 12L may set the number of scans such that the higher the printing speed, the smaller the number of scans in the second direction X to be performed on the same recording area of the recording medium P.

The first generator 12H generates the first print data that satisfies the first condition and that causes the number of scans set by the setting unit 12L to be performed on the same recording area of the recording medium P. At this time, the first generator 12H preferably generates the first print data such that the smaller the number of scans set by the setting unit 12L, the larger the number of pixels to be recorded in one scan.

Thus, the image processing apparatus 15 of the second embodiment can generate the first print data that not only provides the advantage provided by the first embodiment but also allows forming a multi-layer image with image quality and printing time adapted to a print condition.

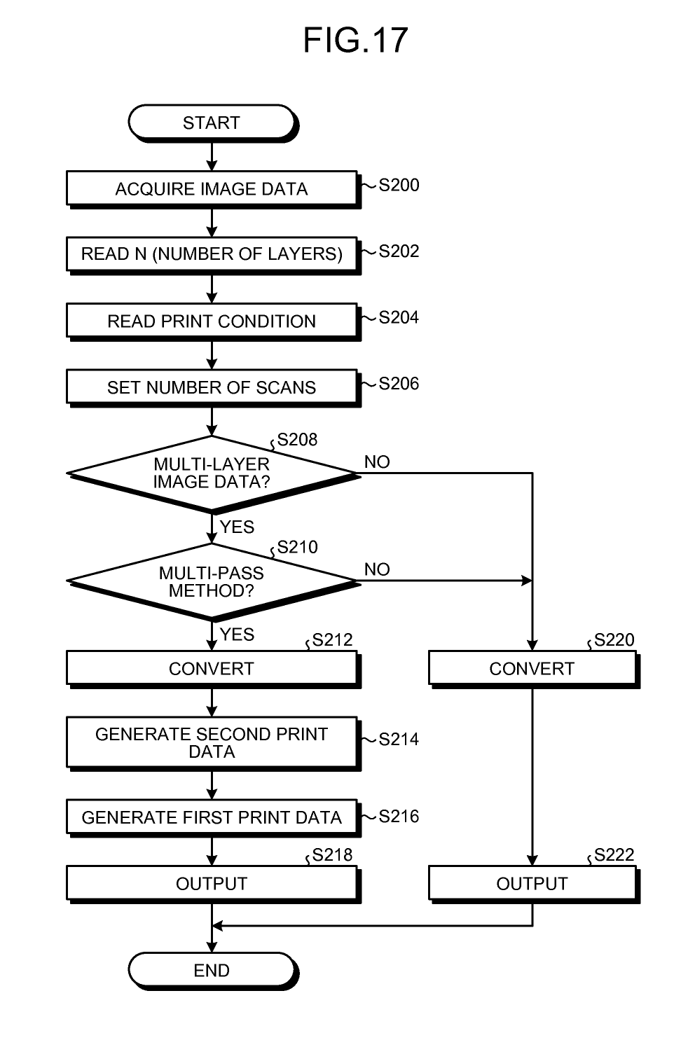

A routine for image processing to be performed by the main control unit 13A of the image processing apparatus 15 is described below. FIG. 17 is a flowchart of the routine for image processing to be performed by the main control unit 13A.

The acquisition unit 12A acquires image data from an external device or the like (not shown) first (step S200). Thereafter, the determination unit 12B reads N, the number of image layers, of the image data acquired at step S200 (step S202).

Thereafter, the setting L reads a print condition (step S204). The print condition may be acquired by the acquisition unit 12A together with the image data from the external device (not shown), for example. Thereafter, the setting L sets the number of scans based on the print condition read at step S204 (step S206).

Thereafter, the determination unit 12B determines whether or not the image data acquired at step S200 is multi-layer image data (step S208). If the image data is multi-layer image data (Yes at step S208), the determination unit 12B determines whether or not the recording unit 14, from which the image is to be output, uses the multi-pass method (step S210). The determination at step S210 may be made as at step S106 (see FIG. 12) of the first embodiment.

If the recording method used by the recording unit 14, from which the image is to be output, is the multi-pass method (Yes at step S210), processing proceeds to step S212.

At step S212, the converter 12G converts the multi-layer image data acquired at step S200 into raster image data (step S212). The conversion at step S212 may be made as at step S108 (see FIG. 12) of the first embodiment.

Thereafter, the second generator 12I generates the second print data from the multi-layer image data converted at step S212 (step S214).

Thereafter, the first generator 12H generates, from the second print data generated at step S214, the first print data that satisfies the first condition and that causes the number of scans, which is set at step S206, to be performed on a same recording area of the recording medium P (step S216).

Thereafter, the output unit 12D outputs the first print data generated at step S216 to the output-target recording apparatus 30 (step S218). Then, the routine ends.

In the recording apparatus 30 that has received the first print data, the recording controller 28 controls the recording unit 14, the irradiator 20, and the driver 26 in accordance with the first print data. As a result, a multi-layer image is formed on the recording medium P.

If the determination made at step S208 is negative (No at step S208), processing proceeds to step S220. If the determination made at step S210 is negative (No at step S210), processing proceeds to step S220.

At step S220, the converter 12G converts the image data acquired at step S200 into raster image data (step S220). The conversion at step S220 may be made as at step S116 (see FIG. 12) of the first embodiment.

Thereafter, the output unit 12D outputs the image data converted at step S220 to the recording apparatus 30 as print data (step S222). Then, the routine ends.

As described above, the image processing apparatus 15 of the second embodiment includes, in addition to the elements of the image processing apparatus 12 of the first embodiment, the setting unit 12L. The setting unit 12L adaptively sets the number of scans in the second direction X to be performed by the recording unit 14 on a same recording area of the recording medium P depending on a print condition.

Accordingly, the image processing apparatus 15 of the second embodiment can generate print data that not only provides the advantage provided by the first embodiment but also allows forming a multi-layer image with image quality and printing time adapted to a print condition.

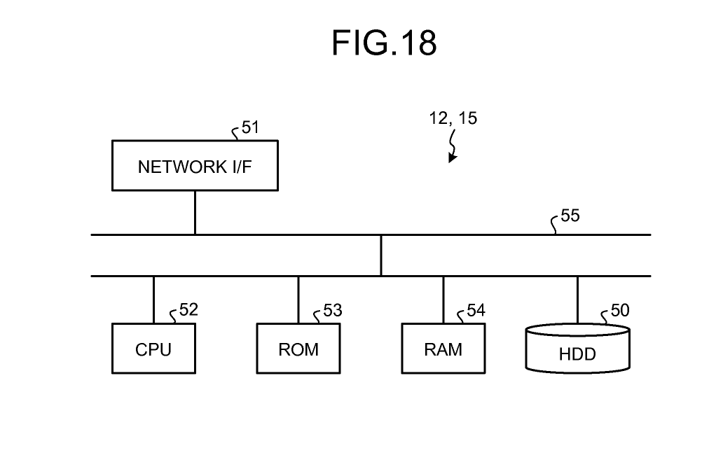

A hardware configuration of each of the image processing apparatus 12 of the first embodiment and the image processing apparatus 15 of the second embodiment (hereinafter, the “image processing apparatus 12, 15”) is described below. FIG. 18 is an explanatory diagram of an example of the hardware configuration of the image processing apparatus 12, 15.

The image processing apparatus 12, 15 includes a CPU 52, a ROM (read only memory) 53, a RAM (random access memory) 54, an HDD (hard disk drive) 50, and a network I/F (interface) 51. The CPU 52, the ROM 53, the RAM 54, the HDD 50, and the network I/F 51 are connected to each other via a bus 55. Thus, the image processing apparatus 12, 15 has a hardware configuration implemented by making use of a general computer.

Program instructions to be executed by the image processing apparatus 12, 15 to execute various processing described above are provided as being stored in the ROM or the like in advance.

The program instructions to be executed by the image processing apparatus 12, 15 to execute various processing described above may be configured to be provided as being recorded in a computer-readable storage medium such as a CD-ROM, an FD (flexible disk), a CD-R, or a DVD (digital versatile disk) in an installable or executable format.

The program instructions to be executed by the image processing apparatus 12, 15 to execute various processing described above may be configured to be provided as being stored in a computer connected to a network such as the Internet and provided by downloading via the network. The program instructions to be executed by the image processing apparatus 12, 15 to execute various processing described above may be configured to be provided or distributed via a network such as the Internet.

The program instructions to be executed by the image processing apparatus 12, 15 to execute various processing described above are configured in modules made up of the above-described units (the acquisition unit 12A, the determination unit 12B, the generation unit 12C, the output unit 12D, the calculation unit 12F, the converter 12G, the first generator 12H, the second generator 12I, the generation unit 12K, and the setting unit 12L). From the viewpoint of actual hardware, the CPU 52 reads out the program instructions from the recording medium such as the ROM 53 and executes the program instructions, thereby loading the above-described units on the main storage device and generating the units on the main storage device.

Thus, according to the embodiments described above, reducing degradation in image quality and simultaneously reducing image forming time for a multi-layer image can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an acquisition unit configured to acquire multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and
a first generator configured to generate first print data from the multi-layer image data so as to satisfy a first condition in which dots corresponding to pixels on different layers of the multi-layer image are recorded by one scan in second and subsequent scans performed on a same recording area of the recording medium.

2. The image processing apparatus according to claim 1, wherein the first generator generates the first print data in which a corresponding number of nozzles, each recording a dot corresponding to a pixel on each layer of the multi-layer image data, are assigned to pixels so as to satisfy the first condition.

3. The image processing apparatus according to claim 1, wherein the first generator generates the first print data in which a pixel adjacent from above to a pixel already recorded in a preceding scan is determined as a pixel to be recorded in a next scan.

4. The image processing apparatus according to claim 1, wherein the first generator includes a setting unit configured to adaptively set the number of scans in the second direction to be performed by the recording unit on the same recording area of the recording medium depending on a print condition.

5. The image processing apparatus according to claim 1, wherein the first generator generates the first print data so that difference in level between layers to which pixels corresponding to dots to be recorded in one scan in the second direction in the multi-layer image data belong is equal to or smaller than a threshold.

6. The image processing apparatus according to claim 1, further comprising a second generator configured to generate second print data in which a corresponding number of nozzles, each recording a dot corresponding to a pixel, are respectively assigned to pixels on each layer of the multi-layer image data, so as to satisfy a second condition in which different ones of the nozzles are assigned to dots corresponding to pixels on different layers at a same pixel location,
wherein the first generator generates the first print data from the second print data.

7. The image processing apparatus according to claim 6, wherein the second generator generates the second print data in which allocation of the nozzles assigned to the pixels on the each layer of the multi-layer image data varies from one to another of the layers of the multi-layer image data so as to satisfy the second condition.

8. The image processing apparatus according to claim 7, further comprising a storage unit configured to store allocation information that defines the allocation for each of the layers, the allocation varying from one to another of the layers,
wherein the first generator changes, on a per-layer basis of the layers of the multi-layer image data, the allocation of the nozzles assigned to the pixels of the multi-layer image data based on the allocation information for the layers.

9. A non-transitory computer-readable storage medium with an executable program stored thereon and executed by a computer, wherein the program instructs the computer to perform:
acquiring multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and
generating first print data from the multi-layer image data so as to satisfy a first condition in which dots corresponding to pixels on different layers of the multi-layer image are recorded by one scan in second and subsequent scans performed on a same recording area of the recording medium.

10. An image processing method comprising:
acquiring multi-layer image data representing a multi-layer image formed by a recording unit including a plurality of nozzles arranged in a first direction, each nozzle ejecting a droplet to record a dot, the recording unit being configured to be moved in the first direction relative to a recording medium each time the recording unit is scanned in a second direction intersecting the first direction; and
generating first print data from the multi-layer image data so as to satisfy a first condition in which dots corresponding to pixels on different layers of the multi-layer image are recorded by one scan in second and subsequent scans performed on a same recording area of the recording medium.
